(19) United States
(12) Patent Application Publication
(10) Pub. No.: US 2017/0355630 A1
(43) Pub. Date: Dec. 14, 2017

(54) PRODUCED WATER DISTILLATION SYSTEM AND METHOD

(71) Applicant: Mission West, LLC, The Woodlands, TX (US)

(72) Inventors: Stephen Ernest Hardwick, Tomball, TX (US); David Carol Harris, Tomball, TX (US); Nelson David Henry, Tomball, TX (US)

(73) Assignee: Mission West, LLC, The Woodlands, TX (US)

(21) Appl. No.: 15/468,946

(22) Filed: Mar. 24, 2017

Related U.S. Application Data
(60) Provisional application No. 62/392,775, filed on Jun. 10, 2016.

(51) Int. Cl. C02F 9/00; C02F 1/02; C02F 1/04; C02F 1/00; C02F 1/26

(52) U.S. Cl. CPC C02F 9/00; C02F 1/04; C02F 1/001; C02F 1/02; C02F 1/26; C02F 1/00

(57) ABSTRACT

A system for treating a produced water stream to separate the water into a final concentrated brine stream and a final distillate stream includes a first flash vessel for separating the produced water stream into a first distillate stream and a first concentrated brine stream, a second flash vessel connected to the first flash vessel separates the first concentrated brine stream into a second distillate stream and a second concentrated brine stream, a third flash vessel connected to the second flash vessel separates the second concentrated brine stream into a third distillate stream and a final concentrated brine stream, a first pre-heater heat exchanger for heating the produced water stream by the final distillate stream of combination of the first distillate stream from the first flash vessel, the second distillate stream from the second flash vessel and the third distillate stream from the third flash vessel, a second pre-heater heat exchanger connected to the first pre-heater heat exchanger, for heating the produced water stream from the first pre-heater heat exchanger by the concentrated brine stream from the third flash vessel, a third pre-heater heat exchanger connected to the second pre-heater heat exchanger, for heating the produced water stream from the second pre-heater heat exchanger by the third distillate stream from the third flash vessel, a pump connected to the third pre-heater heat exchanger for pumping the produced water stream at positive pressure, an electrical heater connected to the pump for heating the produced water stream, and a waste heat exchanger connected to the first electrical heater for heating the produced water stream.

### CROSS-REFERENCE TO RELATED APPLICATION

The present application is a conversion of and has benefit of priority of the following application, which is co-pending and has at least one same inventor of the present application: U.S. Provisional Patent Application No. 62/392,775, titled “Produced Water Distillation System”, filed Jun. 10, 2016.

### TECHNICAL FIELD

The present invention generally relates to water treatment, and more particularly relates to produced water distillation systems and methods.

### BACKGROUND

Oil and gas reservoirs often contain water as well as hydrocarbons. The water is sometimes found in a zone that lies under the hydrocarbons, and sometimes in the same zone with the oil and gas. In addition to water found in the geologic formation, energy companies often use hydraulic fracking techniques that introduce large amounts of water into the wells. This water when returned to the surface is referred to as flowback. Produced water is the term used in the oil industry to describe water found in the geologic formation and result of flowback, that is produced as a byproduct along with oil and gas.

Whether from water in the formation or production techniques (e.g. fracking or water flooding), there are often large amounts of produced water at a well site that must be disposed of (e.g. by injection well), treated or recycled. Produced water obtained from oil and natural gas drilling and production may contain organic materials, oils, volatile compounds, semi-volatile compounds, metal compounds, and suspended/dissolved solids. It would be desirable, and in some cases is required, to reduce the amounts of these materials in water to be repurposed. It would also be desirable to reduce impurities in water that is to be disposed.

Produced water, including flowback water, can have contaminants that make treatment of the water crucial. In fact, because of regulations in most scenarios, treatment for safe disposal of the produced water is a strict requirement. Over the years, environmental regulators have become vigilant in regulating unwanted waste products from natural gas and oil production, and the handling of produced water is part of this increased regulatory scrutiny.

Because of the large amounts of produced water that can come out of a well, the treatment or disposal of the produced water is a huge issue and cost for oil and gas producers. Transportation and disposal costs for produced water, and environmental impact that both transportation and disposal entail, make it desirable to limit the amount of produced water that needs to be disposed of or sent off site for treatment.

One method of limiting the amount of produced water that is either transported off site, or disposed of, is on-site treatment of produced water by heating. Through the heating, pure water is distilled off of the produced water, leaving a concentrated brine byproduct. The distilled water has only limited contaminants so it can be repurposed for use in various ways that are cost effective for the operator of the well (e.g. recycled to be reused in wells or, where approved by regulatory, can be re-introduced back into the environment for irrigation, agricultural uses, or added to a stream or river). The brine byproduct stream also can be used in various ways including for drilling and workover fluids. To the extent that produced water can be treated onsite to distill off pure water and a brine byproduct, this can have positive environmental impacts and potential cost savings for the oil and gas producers.

Despite the desirability of on-site distillation of produced water, on-site distillation is rarely employed at oil and gas sites for a variety of reasons. Conventional methods of heating produced water to distill off pure water include: (1) simply boiling the produced water using direct heating and large distillation columns or boilers; and (2) mechanical vapor recompression (MVR sometimes integrates multiple effect distillation (MED) leading into the MVR).

Simply boiling produced water using direct heat and a distillation unit is simple and easy to do, but is extremely energy intensive because it wastes huge amounts of energy. The heated water and steam is not recycled to make the entire system more energy efficient.

Mechanical vapor recompression (sometimes combined with multi effect distillation), on the other hand, attempts to lower the energy required to boil the produced water and generate pure distillate and a brine byproduct. MVR (sometimes also referred to as Mechanical Vapor Compression (MVC)) is an evaporation method by which boiled off steam is recompressed and thus pressurized. The increase in pressure raises the temperature at which the phase change occurs for a given fluid. By holding the distillate and brine concentrate at a pressure differential, a minimum temperature differential can be held while the fluids both change phase. The minimum temperature differential allows for efficient internal exchange of latent heat energy. This effectively recycles the latent heat, which makes up a large portion of the overall energy requirements.

MVR systems are often paired with multiple effect distillation. Such systems utilize a similar effect of recycling latent heat energy. Instead of cycling the energy back on the feed to the system, MEDs boil off a portion of the total target mass to be boiled. The fluids are then split into gaseous and liquid streams. The steam and liquid are fed into a heat exchanger's hot and cold sides respectively. Due to a small, but significant pressure drop in the liquid side of the stream, both go through phase changes as the latent heat from the steam is passed to the liquid side. This allows for a reduction in the heat power required to continuously distill in proportion to the number of such effects placed in series.

A problem with MVR/MED units is that they operate at pressures below atmospheric (i.e. under a partial vacuum), therefore, sizes of the various pipes and equipment needs to be quite large in order to handle the volumes or flow rates needed at an oil or natural gas operation. The volume of steam at a vacuum of −15 psig can be as much as two orders of magnitude larger than the same amount of gas at a positive pressure of 25-55 psig. Obviously this type process requires large piping and other equipment that is not typically mobile and able to be used at remote sites. As an example, the compressor necessary to recompress the amount of steam from a produced water distillation process at a typical wellhead might be 60+ horsepower and be the size of a room in a house.

Positive pressure methods of heating water to produce steam are counter intuitive because when pressure goes up the initial amount of energy needed to boil the water also goes up. Accordingly, most methods of boiling water operate either at vacuum or atmospheric pressure. The problem with conventional low pressure systems is that the equipment and piping needs to be much larger than what is practical for a mobile system usable at well sites.

It would therefore be desirable, and a significant improvement in the art and technology, to provide a method and system of treating produced water on site at an oil or gas well that is more energy efficient than simply boiling water at atmospheric pressure and separating the distillate from the brine stream. It would also be desirable to provide a method and system of treating produced water at a wellhead that has a small footprint and is mobile so that the system can be transported from well site to well site when required. It would further be desirable to provide a method and system of treating produced water that can treat larger quantities of produced water than is possible with conventional systems of small footprint and mobility. It would also be desirable to provide a method and system of treating produced water that can secondarily minimize the quantity of distillate through the release of steam, while maintaining operational efficiencies.

### SUMMARY

Disclosed herein is a system and method for treating produced water from an oil or natural gas well using a positive pressure multi-effect distillation. The positive pressure multi-effect distillation receives produced water and separates the produced water into a concentrated brine water stream and a distilled water stream.

An embodiment of the invention is a system for treating a produced water stream to separate the water into a final concentrated brine stream and a final distillate stream. The system includes a first flash vessel for separating the produced water stream into a first distillate stream and a first concentrated brine stream, a second flash vessel connected to the first flash vessel for separating the first concentrated brine stream into a second distillate stream and a second concentrated brine stream, a third flash vessel connected to the second flash vessel for separating the second concentrated brine stream into a third distillate stream and the final concentrated brine stream, a first pre-heater heat exchanger for heating the produced water stream by the final distillate stream, the final distillate stream is combination of the first distillate stream from the first flash vessel, the second distillate stream from the second flash vessel and the third distillate stream from the third flash vessel, a second pre-heater heat exchanger connected to the first pre-heater heat exchanger, for heating the produced water stream from the first pre-heater heat exchanger by the final concentrated brine stream from the third flash vessel, a third pre-heater heat exchanger connected to the second pre-heater heat exchanger, for heating the produced water stream from the second pre-heater heat exchanger by the third distillate stream from the third flash vessel, a pump connected to the third pre-heater heat exchanger for pumping the produced water stream at positive pressure to the first flash vessel, an electrical heater connected to the pump for heating the produced water stream, and a waste heat exchanger connected to the first electrical heater for heating the produced water stream.

Another embodiment of the invention is a system for treating a produced water stream to separate the water into a concentrated brine stream and a distillate stream. The system includes a flash vessel for separating the produced water stream into the distillate stream and the concentrated brine stream, a first pre-heater heat exchanger for heating the produced water stream by the distillate stream, a second pre-heater heat exchanger connected to the first pre-heater heat exchanger, for heating the produced water stream by the concentrated brine stream, a pump connected to the second pre-heater heat exchanger for pumping the produced water stream at positive pressure to the flash vessel, and a heater connected to the pump and the flash vessel for heating the produced water stream fed to the flash vessel.

Yet another embodiment of the invention is a method of treating a produced water to separate the produced water into a final concentrated brine stream and a final distillate stream/The method includes first pre-heating the produced water by the final distillate stream, second pre-heating the produced water by the final concentrated brine stream, third pre-heating the produced water by a water vapor stream from a final flash vessel, pumping the produced water to obtain a positive pressure, heating the produced water from pumping by a heater, and flashing the produced water from heating in the final flash vessel to obtain the final concentrated brine stream and the water vapor stream as the final distillate stream.

Another embodiment of the invention is a method of treating a produced water stream to separate the produced water stream into a final concentrated brine stream and a final distillate stream. The method includes pre-heating the produced water stream by the final distillate stream, the final concentrated brine stream and a final water vapor from a final effect of a multi-effect distillation unit, pressurizing the produced water stream to above atmospheric pressure, heating the produced water stream by an equipment selected from the group consisting of: gas turbine, hydraulic heater, electric heater, and combinations, and flashing the produced water stream in a multi-effect distillation unit, each effect of the multi-effect distillation unit includes a respective flash tank and a respective heat exchanger, each effect delivers a respective concentrated brine stream and a respective water vapor stream, each respective heat exchanger heats the respective concentrated brine stream by the respective water vapor stream for delivery of the respective concentrated brine stream to a next effect of the multi-effect distillation unit, and the respective heat exchanger of the final effect of the multi-effect distillation unit employs the final water vapor for pre-heating.

### BRIEF DESCRIPTION OF THE DRAWINGS

The present invention is illustrated by way of example and not limitation in the accompanying figures, in which like references indicate similar elements, and in which:

FIG. 1 illustrates a process flow diagram of a positive pressure multi-effect distillation unit, according to certain embodiments of the invention;

FIG. 2 illustrates a method of distilling produced water under positive pressure, according to certain embodiments of the invention; and

FIG. 3 illustrates a non-exclusive equipment list of the positive pressure multi-effect distillation unit, according to certain embodiments of the invention.

### DETAILED DESCRIPTION

Embodiments herein are discussed in the context of produced water from oil or natural gas drilling and production, however, it will be understood that embodiments may be used in any situation where impurities exist to be removed from water. Embodiments will be described more fully hereinafter with reference to the accompanying drawings. Like numbers refer to like elements throughout.

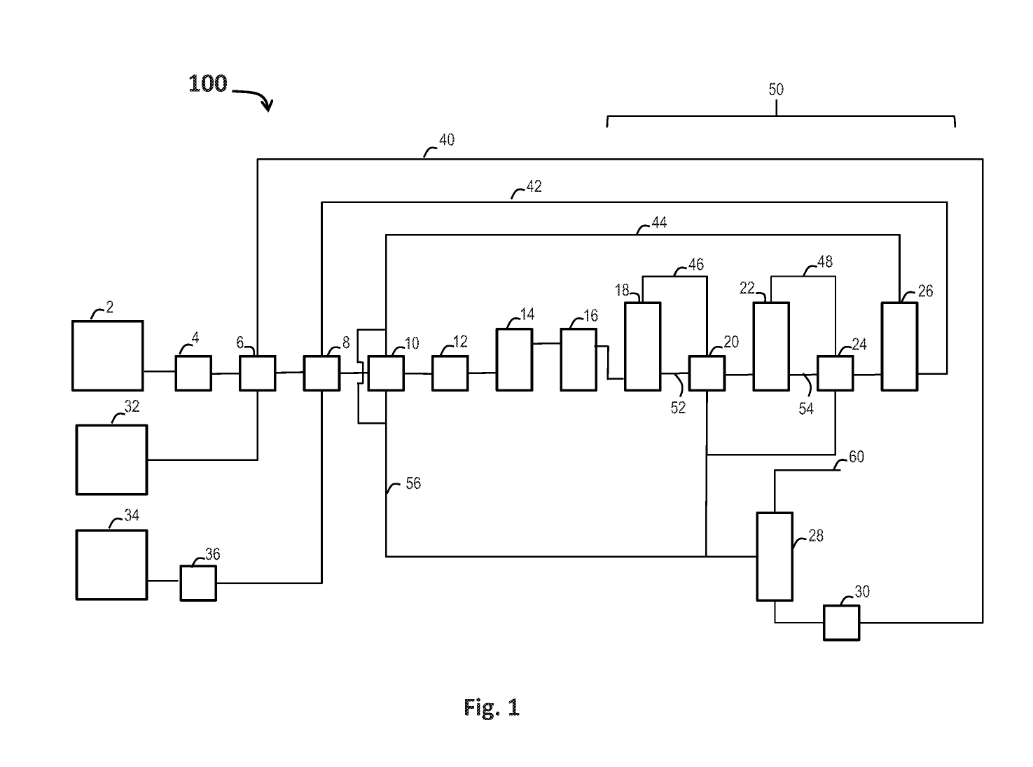

Referring to FIG. 1, a system 100 includes a feed brine storage 2. Feed brine of the storage 2 may be, for example, a produced water from an oil or gas well at about 40° F. and containing total dissolved solids (TDS) of between about 20,000 ppm and about 180,000 ppm. The description that follows is for one particular feed brine composition with TDS of 100,000 ppm and operating at relatively steady state with a feed brine flow rate of about 59 gpm from a first pump 4 connected to the storage 2. The temperatures, pressures, and flowrates set out below would differ for water having a different TDS composition, for different flow rates, and for ramp up to steady state operations. While produced water as the feed brine is discussed in the detailed process description, the system and its process could also be used with other fluids and in other industries.

The first pump 4 is connected to the storage 2 for pumping the feed brine to a first pre-heat heat exchanger 6. The first pump 4 may be an about 5 hp pump and may feed the feed brine at a rate of about 59 gallons per minute at a pressure of about 40 psi, although the system 100 could treat up to about 90 gallons per minute of feed brine depending on the composition. The first pre-heat heat exchanger 6 heats the feed brine to about 111° F. by means of a distilled water stream 40 from a flash vessel 28 connected to an outlet of a water vapor heat exchanger 10, a first post effect heat exchanger 20 and a second post effect heat exchanger 24. After pressure drop in the first pre-heat heat exchanger 6, pressure of the feed brine is about 14 psi.

The feed brine is then fed to a second pre-heat heat exchanger 8 connected to the first pre-heat heat exchanger 6. The second pre-heat heat exchanger 8 heats the feed brine to about 175° F. by means of a concentrated brine stream 42 from a final effect 26 of a multi-effect distillation unit 50. After pressure drop in the second pre-heat heat exchanger 8, pressure of the feed brine is about 6 psi.

The feed brine is then fed to a water vapor heat exchanger 10 connected to the second pre-heat heat exchanger 8. The water vapor heat exchanger 10 heats the feed brine to about 224° F. by means of a water vapor stream 44 from the final effect 26 of the multi-effect distillation unit 50. After pressure drop in the water vapor heat exchanger 10, pressure of the feed brine is about 2 psi.

The feed brine is then compressed by a second pump 12 and restrictors (not shown in detail) connected to the water vapor heat exchanger 10. The second pump 12 is an about 5 hp pump and together with the restrictors increases the pressure of the brine feed to about 55 psi. At the flow rates anticipated, this dramatic rise in the pressure of feed brine can be created by a pump of only about 5 hp. This size pump 12 has a very small footprint and uses a small fraction of the energy required by the room-sized compressors used in conventional MVR processes. This difference in the energy requirements of the differing methods of generating pressure is the reason that, at steady state, the process described herein is competitively energy efficient as compared to the conventional MED and MVR processes.

The second pump 12 connects to a turbine waste heat exchanger 14 associated with a natural gas turbine/generator set (not shown in detail). This waste heat exchanger 14 is the first heat exchanger of the process that is using heat generated from outside of the process when the process is running at steady state. A waste heat recovery system may be used to capture the exhaust energy of the turbine engine via the turbine waste heat exchanger 14 to heat the incoming brine to the appropriate temperature to enter a heater 16.

A heater 16, such as an electrical heater that is powered by electricity from the natural gas turbine/generator set (not shown in detail), is connected to the waste heat exchanger 14. This heater 14 is the second heat exchanger of the process that is using heat generated from outside of the process when the process is running at steady state. While in this particular embodiment the electric energy and waste heat is generated by a gas turbine, other forms of heat generation may be employed to further heat the brine feed (e.g. electrical heaters, hydraulic heaters, direct heating using furnaces and so forth).

In certain non-exclusive embodiments, the source of the energy for heating the water (and other process requirements) via the waste heat exchanger 14 and the heater 16 is an about 1200 hp turbine engine. The turbine may be powering a generator for electrical power that may be used to energize heating elements, such as the heater 16, to heat the incoming brine and to run other ancillary equipment such as pumps, lights and so forth.

In certain non-exclusive embodiments, the turbine engine is a Solar Saturn 10 gas turbine from Caterpillar. The primary fuel for the turbine engine may be natural gas (but there may be an option for other fuels). This turbine can run on natural gas available at the well site, it is rugged, reliable and energy efficient because its waste heat is readily usable in the turbine waste heat exchanger 14 connected to the heater 16. A waste heat recovery system may be used to capture the exhaust energy of the turbine engine via the turbine waste heat exchanger 14 to heat the incoming brine to the appropriate temperature to enter the heater 16 prior to the multi-effect distillation unit 50.

In certain non-exclusive embodiments, after leaving turbine waste heat exchanger 14 the feed brine is next piped to the heater 16 connected to the turbine waste heat exchanger 16. It is possible to reverse this configuration and have electric heater 16 be the first turbine generated heat exchanger and the turbine waste heat exchanger 14 be the second heat exchanger in the configuration. Heater 16 further heats and ultimately causes phase change to the feed brine. The feed brine leaving the heater 16 is about 19.5% vapor at a temperature of about 306° F. and pressure of about 51 psi.

The feed brine from the heater 16 is then fed to the multi-effect distillation unit 50. The multi-effect distillation unit 50 is at high pressure (i.e., pressure above atmospheric pressure) for further vaporizing the feed brine. The vapor outputs of the multi-effect distillation 50 are employed as heating fluid for heat exchangers 20, 24 following respective flash vessels 18, 22 of the multi-effect distillation 50.

The feed brine stream leaving the heater 16 is piped to a first flash vessel 18 connected to the waste heat exchanger 16. In alternatives, the first flash vessel 18 may include the heater 16, such as for example a kettle reboiler. The first flash vessel 18 separates the liquid/vapor mixture of the feed brine into a first MED water vapor stream 46 and a first MED concentrated brine stream 52. After flashing off the first MED water vapor stream 46, the remaining first MED concentrated brine stream 52 comprises about 110,000 TDS (versus about 100,000 TDS of the feed brine into the first flash vessel 18). The flow rate of the concentrated brine stream 52 drops to about 50 gpm (from about 59 gpm for the feed brine into the first flash vessel 18). Temperature of the first MED concentrated brine stream 52 is about 306° F. and pressure is about 51 psi. Temperature of the first MED water vapor stream 46 is about 307° F. and pressure is about 51 psi.

The first MED concentrated brine stream 52 is fed to a first MED heat exchanger 20 connected to the first MED flash vessel 18. The concentrated brine stream 52 enters the heat exchanger 20 at about 294° F. and pressure of about 39 psi. Heating fluid for the first MED heat exchanger 20 is the first MED water vapor stream 46. The first MED heat exchanger 20 causes a partial phase change in the first MED concentrated brine stream 52, such that the first MED concentrated brine stream 52 leaving the first MED heat exchanger 20 is about 26% vapor, at temperature of about 291° F. and pressure of about 35 psi.

In the first MED heat exchanger 20, the first MED water vapor stream 46 goes through at least a partial phase change as the water vapor at least partially condenses. The partially condensed water vapor from the first MED heat exchanger 20 is piped to a flash pot 28 connected to the first MED heat exchanger 20. The water vapor from the first MED heat exchanger 20 more fully condenses to form distilled water 40 and steam 56. The steam 60 may be vented, and the distilled water 40 is circulated back to the first pre-heat heat exchanger 6 for heating the feed brine to the heat exchanger 6. The distilled water exits the first pre-heat heat exchanger 6 and travels to distilled water storage 32.

The first MED concentrated brine stream 52 from the first MED heat exchanger 20 is fed to a second MED flash vessel 22 connected to the first MED heat exchanger 20. The second MED flash vessel 22 separates the liquid/vapor mixture of the concentrated brine stream 52 into a second MED water vapor stream 48 and a second MED concentrated brine stream 54. After flashing off the second MED water vapor stream 48, the remaining second MED concentrated brine stream 54 comprises about 133,000 TDS (versus about 110,000 TDS of the first MED concentrated brine stream 52). The flow rate of the second MED concentrated brine stream 54 drops to about 36 gpm (from about 50 gpm for the first MED concentrated brine stream 52 into the second MED flash vessel 22). Temperature of the second MED concentrated brine stream 54 is about 291° F. and pressure is about 35 psi.

The second MED concentrated brine stream 54 is fed to a second MED heat exchanger 24 connected to the second MED flash vessel 22. The second MED concentrated brine stream 54 enters the heat exchanger 24 at about 276° F. and pressure of about 25 psi. Heating fluid for the second MED heat exchanger 24 is the second MED water vapor stream 48. The second MED heat exchanger 24 causes a partial phase change in the second MED concentrated brine stream 54, such that the second MED concentrated brine stream 54 leaving the second MED heat exchanger 24 is about 36.5% vapor, at temperature of about 279° F. and pressure of about 21 psi.

In the second MED heat exchanger 24, the second MED water vapor stream 48 goes through at least a partial phase change as the water vapor at least partially condenses. The partially condensed water vapor from the second MED heat exchanger 24 is piped to the flash pot 28 connected to the second MED heat exchanger 24. The water vapor from the second MED heat exchanger 24 more fully condenses to form distilled water 40 and steam 56. The steam 60 may be vented, and the distilled water 40 is circulated back to the first pre-heat heat exchanger 6 for heating the feed brine to the heat exchanger 6. The distilled water exits the first pre-heat heat exchanger 6 and travels to distilled water storage 32.

The second MED concentrated brine stream 54 from the second MED heat exchanger 24 is fed to a third MED flash vessel 26 connected to the second MED heat exchanger 24. The third MED flash vessel 26 separates the liquid/vapor mixture of the concentrated brine stream 54 into a final MED water vapor stream 44 and a final MED concentrated brine stream 42. After flashing off the final MED water vapor stream 44, the remaining final MED concentrated brine stream 42 comprises about 198,000 TDS (versus about 133,000 TDS of the second MED concentrated brine stream 54). The flow rate of the final MED concentrated brine stream 42 drops (from about 36 gpm for the second MED concentrated brine stream 54 into the third MED flash vessel 26). Temperature of the final MED concentrated brine stream 42 is about 279° F. and pressure is about 20 psi.

The final MED concentrated brine stream 42 is fed to the second pre-heat heat exchanger 8 connected to the third MED flash vessel 26. The final MED concentrated brine stream 42 heats the brine feed in the second pre-heat heat exchanger 8. After heating in the heat exchanger 8, the final MED concentrated brine stream 42 is pumped by a pump 36 connected to the second pre-heat heat exchanger 8 to a concentrated brine storage 34.

The final MED water vapor stream 44 is fed to the third pre-heat heat exchanger 10 connected to the third MED flash vessel 26. The final MED water vapor stream 44 heats the brine feed in the third pre-heat heat exchanger 8 before the brine stream is pressurized by the pump 12. In the third pre-heat heat exchanger 8, the final MED water vapor stream 44 goes through a phase change and the vapor is distilled in a distillate 56 that is also piped to the flash pot 28 connected to the third pre-heat heat exchanger 8. The flash pot 28 ensures that all the vapor and flash from dropping to atmospheric pressure is released allowing only condensed steam in the final distillate stream of the distilled water 40.

A distillate pump 30 connected to the flash pot 28 and the first pre-heat heat exchanger 6 pumps the distilled water 40 from the flash pot 28 to the first pre-heat heat exchanger 6 and thereafter on to the distilled water storage 32.

Some of the final MED water vapor stream 44 that is fed to the third pre-heat heat exchanger 10 may be diverted around the heat exchanger 10 to regulate the amount of latent heat introduced in the feed brine by the third pre-heat heat exchanger 10. Managing this heating allows for the system 100 to operate at a wider range of TDS of the feed brine. This limits the heat recycling to avoid vapor lock of the pump 12.

In steady state operation, the produced water of the feed brine is pumped from the feed brine storage 2 to the first pre-heat heat exchanger 6. The distilled water 40 from the flash pot 28 from effects of the first flash vessel 18 and the second flash vessel 48, after use in the first MED heat exchanger 20 and the second MED heat exchanger 24, and the third flash vessel 26, after use in the third pre-heat heat exchanger 10, is passed through the heat exchanger 6 to heat the feed brine. The distilled water 40 is then fed to the distilled water storage 32.

The feed brine is thereafter fed to the second pre-heat heat exchanger 8. The final MED concentrated brine stream 42 is fed from the third flash vessel 26 to the second pre-heat heat exchanger 8 to further heat the feed brine. The final MED concentrated brine stream 42 is pumped by the pump 36 to the concentrated brine storage 34.

The feed brine from the second pre-heat heat exchanger 8 is fed to the third pre-heat heat exchanger 10. The final water vapor 44 from a final effect of the third flash vessel 26 is fed from the third flash vessel 26 to the third pre-heat heat exchanger 10. A bypass of the third pre-heat heat exchanger 10 allows some of the final water vapor 44 to be diverted around the third pre-heat heat exchanger 10 to regulate the amount of heating of the feed brine. Managing the heating allows for the system 100 to operate at a wider range of TDS and avoids vapor lock of the pump 12. The final water vapor 44, after passing through or being diverted around the third pre-heat heat exchanger 10, is passed to the flash pot 28.

The feed brine then proceeds to the pressurizing pump 12 where the feed brine is subjected to a positive pressure prior to distillation by the multi-effect distillation unit 50. The feed brine from the pump 12 is further heated by the heater 14 and the waste heat exchanger 16. The further heating increases the temperature at positive pressure above the flash point for the feed brine.

The feed brine then proceeds to a first flash vessel 18 where the feed brine is separated into the first MED water vapor stream 46 and the first MED concentrated brine stream 52. The first MED water vapor stream 46 is passed through the first MED heat exchanger 20, together with the first MED concentrated brine stream 52, to reheat the first MED concentrated brine stream 52 for the second MED flash vessel 22.

The first MED concentrated brine stream 52 is fed to the second MED flash vessel 22. At the second MED flash vessel 22, the first MED concentrated brine stream 52 is separated into the second MED water vapor stream 48 and the second MED concentrated brine stream 54. The second MED water vapor stream 48 is passed through the second MED heat exchanger 24, together with the second MED concentrated brine stream 54, to reheat the second MED concentrated brine stream 54 for the final MED flash vessel 26.

The second MED concentrated brine stream 54 then proceeds to the final MED flash vessel 26. At the final MED flash vessel 26, the second MED concentrated brine stream 54 is separated into the final water vapor 44 and the final MED concentrated brine stream 42. The final water vapor 44 is passed to the third pre-heat heat exchanger 10 or diverted around the third pre-heat heat exchanger 10, as applicable. The final water vapor 44 is then passed to the flash pot 28 for emission of steam 60 and passage of the distilled water 40 back to the first pre-heat heat exchanger 6 and thereafter to distilled water storage 32. The final MED concentrated brine stream 42 is passed to the second pre-heat heat exchanger 8. The final MED concentrated brine stream 42 is then passed from the second pre-heat heat exchanger 8 to the pump 36 and into concentrated brine storage 34.

In order to get to a steady state process, an operator would start with a flowrate low enough to start making steam in one pass. This flow rate would typically be roughly half of the steady state flow rate or less for a given feed fluid composition. For the process described herein with a steady state flow rate of almost 60 gpm that means a start up flow rate of roughly 30 gpm. As the startup process continues, it starts to fill the vapor and heat recycling lines. As this occurs, an operator or an automatic control system (most likely this would occur using a computer control system) would gradually ramp up the flow rates until the process is stable at making a correct amount of steam for inlet TDS so outlet TDS of the final MED concentrated brine stream 42 reaches about 198,000 TDS. The outlet for the brine has an analyzer that controls the brine exit path. If the brine is not to the concentration of 198,000 TDS, it returns to the feed tank. Once at 198,000 TDS, outlet is set to flow to the concentrated brine storage 34 and the steady state process begins.

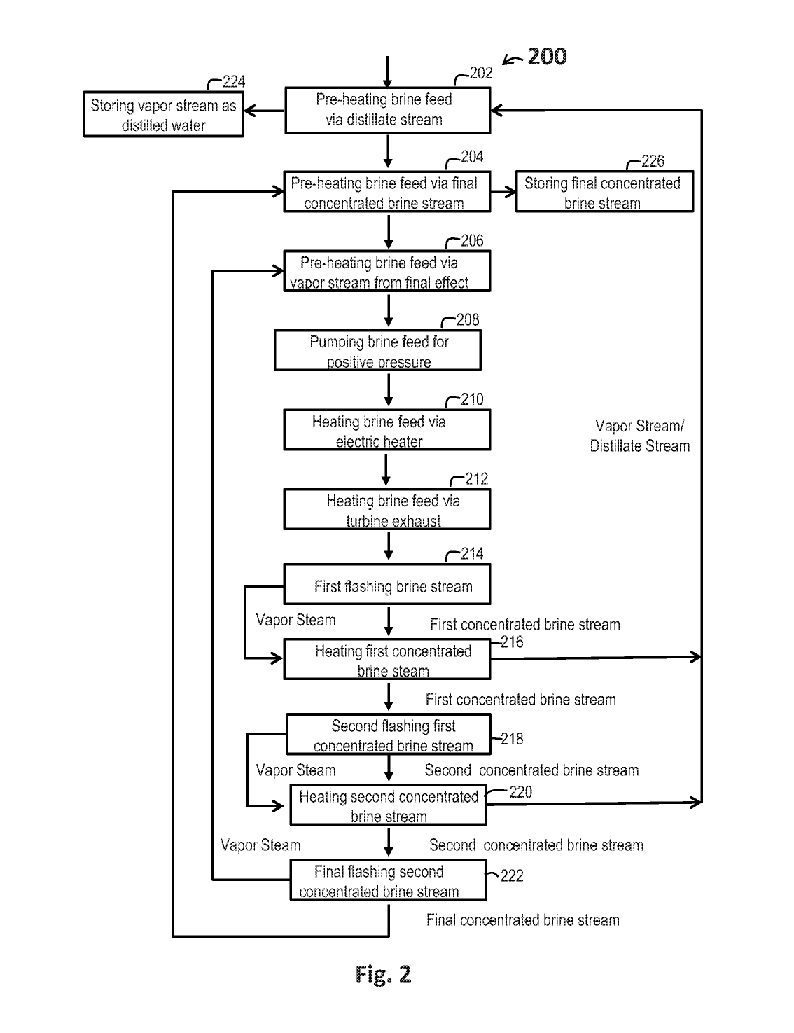

Referring to FIG. 2, a method 200 of steady state operation, for non-exclusive example, of the system 100, includes pre-heating 202 a brine feed by a distilled water from a multi-effect distillation unit. The distilled water may be obtained from a flash pot for a water vapor from the multi-effect distillation unit. The brine feed is then pre-heated 204 by a final concentrated brine stream from the multi-effect distillation unit. Further, the brine feed is pre-heated 206 by a water vapor stream from a final effect of the multi-effect distillation unit.

The brine feed is then pumped 208 to achieve a positive pressure of the brine feed. The brine feed is further heated 210, such as by an electric heater and a turbine waste heater. After further heating 210, the brine feed is first flashed 212 in a flash vessel of the multi-effect distillation unit. The flash 212 obtains a first water vapor and a first concentrated brine stream. The first water vapor heats 214 the first concentrated brine stream and then passes to the flash pot.

The first concentrated brine stream is second flashed 216 in another flash vessel of the multi-effect distillation unit. The flash 216 obtains a second water vapor and a second concentrated brine stream. The second water vapor heats 218 the second concentrated brine stream and then passes to the flash pot.

The second concentrated brine stream is again flashed 220 in a final flash vessel of the multi-effect distillation unit. The flash 220 obtains a final water vapor and a final concentrated brine stream. The final water vapor supplies pre-heating 206 of the brine feed and then passes to the flash pot and then passes 224 to a distilled water storage. The final concentrated brine stream supplies pre-heating 204 of the brine feed and then passes to a concentrated brine storage.

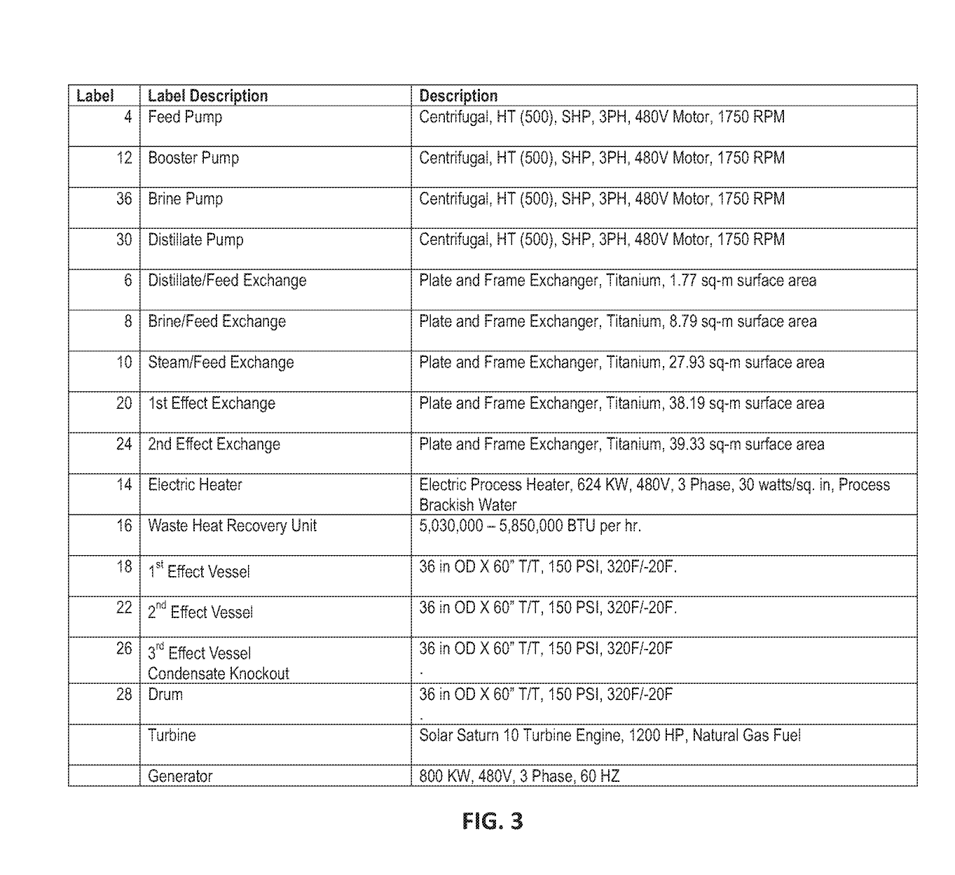

Referring to FIG. 3, a non-exclusive list of equipment provides the multi-effect distillation system 100. Operating the multi-effect distillation system at positive pressure, the equipment needed to treat a steady state stream of produced water at a typical well head (e.g. depending on the salt concentration, up to as much as 50-120 gallons per minute) can be sized so that both the power source (e.g. a natural gas turbine) and all the MED equipment (e.g. flash tanks, pumps, heat exchangers, piping and so forth) can be placed upon as few as two standard size tractor trailers. This allows the positive pressure MED systems to be taken from site to site as needed.

Despite an increase in energy needed to begin boiling produced water by the positive pressure multi-effect distillation system (i.e. because of the higher pressure as compared to the atmospheric or vacuum pressures of conventional distillation processes or conventional MVR/MED processes), at steady state, the energy efficiency of the positive pressure MED process is better or comparable to that of the conventional MVR processes. This anomalous energy efficiency result is based at least partly upon highly efficient recycling of heated fluid and vapor streams from outlet to inlet heating and the use of high efficiency insulation. Importantly, the pressurized multi-effect distillation of the present system, as compared to the conventional MVR process, requires less energy than the energy intensive 60+ horsepower compressor required to recompress steam in the conventional MVR processes. Because the pressurized multi-effect distillation utilizes higher pressures and the system is pressurized in a controlled volume directly onto a nearly incompressible liquid, an about 5 horsepower pump is employed in combination with a pressure reducing valve to pressurize the system.

The energy difference of the 5 horsepower pump versus the 60+ horsepower compressor in the conventional MVR process, means that the positive pressure multi-effect distillation system has potential to run more efficiently at steady state. Although pressurized multi-effect distillation process may require more energy during start up, within a matter of hours to a few days, the steady state operations provide an energy advantage that favorably compares with the conventional MVR processes. Further, there is tremendous savings in cost of equipment (i.e. capital expenditure) for the positive pressure multi-effect distillation system.

Various alternatives are possible in the foregoing embodiments. Choice and sequence of recycled heating fluids and vapors may be varied for the pre-heating. Further, choice and sequence of heaters and waste heat capture for heating may vary depending on site equipment and use. Pump sizing may be varied depending on flow rates and desired resulting concentrated brine stream. Numbers of effects for distillation may vary and be more or less than those of the foregoing embodiments. Pluralities of the disclosed units may be employed in series in certain alternatives. Other variations are possible.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and device(s), connection(s) and element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for treating a produced water stream to separate the water into a final concentrated brine stream and a final distillate stream, comprising:
a first flash vessel for separating the produced water stream into a first distillate stream and a first concentrated brine stream;
a second flash vessel connected to the first flash vessel for separating the first concentrated brine stream into a second distillate stream and a second concentrated brine stream;
a third flash vessel connected to the second flash vessel for separating the second concentrated brine stream into a third distillate stream and the final concentrated brine stream;
a first pre-heater heat exchanger for heating the produced water stream by the final distillate stream, the final distillate stream is combination of the first distillate stream from the first flash vessel, the second distillate stream from the second flash vessel and the third distillate stream from the third flash vessel;
a second pre-heater heat exchanger connected to the first pre-heater heat exchanger, for heating the produced water stream from the first pre-heater heat exchanger by the final concentrated brine stream from the third flash vessel;
a third pre-heater heat exchanger connected to the second pre-heater heat exchanger, for heating the produced water stream from the second pre-heater heat exchanger by the third distillate stream from the third flash vessel;
a pump connected to the third pre-heater heat exchanger for pumping the produced water stream at positive pressure to the first flash vessel;
an electrical heater connected to the pump for heating the produced water stream; and
a waste heat exchanger connected to the first electrical heater for heating the produced water stream.

2. The system of claim 1, wherein the pump is an about 5 hp pump.

3. The system of claim 1, further comprising:
a first post effect heat exchanger connected to the first flash vessel and the second flash vessel, the first post effect heat exchanger heats the first concentrated brine stream by the first distillate stream prior to delivery of the first concentrated brine stream to the second flash vessel; and
a second post effect heat exchanger connected to the second flash vessel and the third flash vessel, the second post effect heat exchanger heats the second concentrated brine stream by the second distillate stream prior to delivery of the second concentrated brine stream to the third flash vessel.

4. The system of claim 1, wherein the first pre-heater heat exchanger, the second pre-heater heat exchanger, the third pre-heater heat exchanger, the electrical heater and the waste heat exchanger heat the produced water stream to about 306° F.

5. The system of claim 3, wherein the pump is an about 5 hp pump and pressure of the produced water stream exiting the pump is about 55 psi.

6. The system of claim 1, further comprising:
a turbine generator, the turbine generator powers the electrical heater and delivers exhaust gas heat to the waste heat exchanger.

7. The system of claim 3, wherein the system is portable on two tractor trailer trucks.

8. The system of claim 3, further comprising:
a bypass of the third pre-heat heat exchanger for regulating the heating by the third distillate stream.

9. A system for treating a produced water stream to separate the water into a concentrated brine stream and a distillate stream, comprising:
a flash vessel for separating the produced water stream into the distillate stream and the concentrated brine stream;
a first pre-heater heat exchanger for heating the produced water stream by the distillate stream;
a second pre-heater heat exchanger connected to the first pre-heater heat exchanger, for heating the produced water stream by the concentrated brine stream;
a pump connected to the second pre-heater heat exchanger for pumping the produced water stream at positive pressure to the flash vessel; and
a heater connected to the pump and the flash vessel for heating the produced water stream fed to the flash vessel.

10. The system of claim 9, wherein the flash vessel includes more than one effect in series, each effect separates the produced water stream into a respective water vapor stream and a respective concentrated brine stream;
wherein each of the respective water vapor stream is combined to obtain the distillate stream;
wherein a final effect of the more than one effect in series delivers the concentrated brine stream as the respective concentrated brine stream of the final effect.

11. The system of claim 10, further comprising:
a third pre-heater heat exchanger for heating the produced water stream by the respective water vapor stream of the final effect.

12. The system of claim 9, wherein the pump is an about 5 hp pump.

13. The system of claim 11, wherein the first pre-heater heat exchanger, the second pre-heat heat exchanger, and the heater heat the produced water stream to about 306° F.

14. The system of claim 9, wherein the pump is an about 5 hp pump and pressure of the produced water stream exiting the pump is about 55 psi.

15. The system of claim 11, further comprising:
a post effect heat exchanger for each effect other than the final effect, the post effect heat exchanger heats the respective concentrated brine stream of the effect by the respective water vapor stream of the effect, prior to delivery of the respective concentrated brine stream to a next successive one of the effect.

16. The system of claim 9, wherein the system is portable on two tractor trailer trucks.

17. A method of treating a produced water to separate the produced water into a final concentrated brine stream and a final distillate stream, comprising:
first pre-heating the produced water by the final distillate stream;
second pre-heating the produced water by the final concentrated brine stream;
third pre-heating the produced water by a water vapor stream from a final flash vessel;
pumping the produced water to obtain a positive pressure;
heating the produced water from pumping by a heater;
flashing the produced water from heating in the final flash vessel to obtain the final concentrated brine stream and the water vapor stream as the final distillate stream.

18. The method of claim 17, wherein the pumping is performed by an about 5 hp pump.

19. The method of claim 17, wherein the first pre-heating is performed by a first pre-heat heat exchanger, the second pre-heating is performed by a second pre-heat heat exchanger, the third pre-heating is performed by a third pre-heat heat exchanger, and the heating includes heating performed by an equipment selected from the group consisting of: electrical heater, gas turbine, hydraulic heater, and combinations.

20. The method of claim 17, wherein flashing is performed by a multi-effect distillation unit, each effect of the multi-effect distillation unit in series, each effect separates the produced water stream into a respective water vapor stream and a respective concentrated brine stream;
wherein each of the respective water vapor stream is combined to obtain the distillate stream;
wherein a final effect of the more than one effect in series delivers the concentrated brine stream as the respective concentrated brine stream of the final flash vessel.

21. The method of claim 17, wherein the first pre-heating, the second pre-heating, the third pre-heating and the heating heat the produced water to about 306° F. for the flashing.

22. A method of treating a produced water stream to separate the produced water stream into a final concentrated brine stream and a final distillate stream, comprising:
pre-heating the produced water stream by the final distillate stream, the final concentrated brine stream and a final water vapor from a final effect of a multi-effect distillation unit;
pressurizing the produced water stream to above atmospheric pressure;
heating the produced water stream by an equipment selected from the group consisting of: gas turbine, hydraulic heater, electric heater, and combinations;
flashing the produced water stream in the multi-effect distillation unit, each effect of the multi-effect distillation unit includes a respective flash tank and a respective heat exchanger, each effect delivers a respective concentrated brine stream and a respective water vapor stream, each respective heat exchanger heats the respective concentrated brine stream by the respective water vapor stream for delivery of the respective concentrated brine stream to a next effect of the multi-effect distillation unit, and the respective heat exchanger of the final effect of the multi-effect distillation unit employs the final water vapor for pre-heating.

23. The method of claim 22, wherein the flashing includes first flashing the produced water in a first effect to obtain a first concentrated brine stream and a first water vapor stream, second flashing the first concentrated brine stream in a second effect to obtain a second concentrated brine stream and a second water vapor stream, and third flashing the second concentrated brine stream in the final effect to obtain the final concentrated brine stream and a third water vapor stream;
further comprising:
combining the first water vapor stream, the second water vapor stream and the third water vapor stream to obtain the final distillate stream.

24. The method of claim 22, wherein the pressurizing is performed by an about 5 hp pump and restrictors.

25. The method of claim 22, wherein the pre-heating and heating heats the produced water stream to about 306° F.

26. The method of claim 22, wherein the pressurizing is performed by an about 5 hp pump and restrictors, and pressure of the produced water stream from pressurizing is about 55 psi.
